(19) United States
(12) Patent Application Publication
(10) Pub. No.: US 2010/0159275 A1
(43) Pub. Date: Jun. 24, 2010

(54) Clad can stock

(76) Inventors: Jeffrey Edward Geho, Aurora, IL (US); Paul Anthony Wycliffe, Amherstview (CA); Karam Singh Kang, Kingston (CA)

Correspondence Address: Christopher C. Dunham;c/o Cooper & Dunham LLP, 30 Rockefeller Plaza, 20th Floor, New York, NY, 10112, US

(21) Appl. No.: 12/653,930

(22) Filed: Dec. 17, 2009

Related U.S. Application Data
(60) Provisional application No. 61/203,652, filed on Dec. 23, 2008.

(51) Int. Cl. B32B 15/01; B21D 43/28

(52) U.S. Cl. 428/654; 72/324

(57) ABSTRACT

Exemplary embodiments of the invention relate to a sheet article having opposed first and second surfaces, and having a core layer, a cladding layer at the first surface of the sheet article, and optionally a cladding layer at the second surface of the sheet article. The cladding layer at the first surface is made of an aluminum alloy selected from alloys AA3104, AA3004 and modified versions of alloys AA3104 and AA3004 additionally containing 1.0 to 2.0 wt % Fe and optionally up to 1 wt % Si. The core layer is an aluminum alloy having a yield strength and/or ductility greater than the yield strength and/or ductility of the alloy of the cladding layer at the first surface. The sheet article may be used as can body stock, can end stock and tab stock.

### CROSS-REFERENCE TO RELATED APPLICATION

This application claims the priority right of co-pending U.S. provisional patent application Ser. No. 61/203,652 filed Dec. 23, 2008 by applicants named herein. The entire contents of application Ser. No. 61/203,652 are incorporated herein by reference.

### BACKGROUND OF THE INVENTION

(1) Field of the Invention

This invention relates to can stock, i.e. metal sheet used for the production of bodies, ends and tabs of beverage cans and similar metal containers. More particularly, the invention relates to can stock made of aluminum alloys.

(2) Description of the Related Art

Beverage cans and similar container bodies and ends are frequently made from aluminum alloy ingots that are rolled to form sheet articles (lengths or pieces of sheet material) having a desired thickness for the fabrication of can bodies (referred to as can body stock or CBS), can end walls (referred to as can end stock or CES) and ancillary parts such as pull rings, pull tabs, and the like (tab stock). For the fabrication of container bodies, the sheet is cut into blanks, cupped, extended by drawing and ironing, trimmed, and then shaped by a number of die necking operations before being closed at the open end by the attachment of an end closure, e.g. a can end wall often provided with a tab, such as a ring-pull opener, an atomizer device (e.g. for aerosol containers) or a screw cap (for so-called metal bottles that simulate glass bottles in shape). Can end walls are fabricated by stamping to form end wall blanks, that are then contoured and scored (e.g. to form an easily-openable tab), and provided with means by which a ring pull device may be attached.

For reasons of economy, there is an ongoing need to reduce the amounts of metal used for container bodies. This can be achieved by making the walls of container bodies ever thinner, and also by reducing the amounts of metal scrap produced during the container manufacturing process. When down-gauging sidewalls of a container body, it necessary that the column strength of the resulting structure remain high enough to handle the filling and closing loads and that the containers be robust enough to resist fracturing and puncturing of the sidewalls when the containers are handled by the shipper and the consumer. However, it is not possible to use the alloys best suited for this purpose. Can body stock is usually made from one of two aluminum alloys, i.e. alloys AA3004 and AA3104, because only these alloys have properties suited for the requirements of the drawing and ironing step, and yet these metals are not particularly strong. When employing these alloys, the need for fracture or puncture resistance alone has generally limited container wall thickness to a minimum of about 0.0036-0.0037 inch. Moreover, for these alloys, if thinner walls are employed, it may be necessary to reform the bottom of the container body (where there is normally an inwardly projecting dome) because the strength at the reduced gauge is insufficient to provide the required growth and buckle characteristics. This would involve an extra manufacturing step and additional equipment.

Unnecessary amounts of metal may also be used because of the need to reject a certain percentage of completed container bodies after the die necking steps because some of the die necked container bodies inevitably exhibit unacceptable pleating, puckering or fracture in the shaped regions as a result of the die necking process. This may be a consequence of metal anisotropy (differences of characteristics in different directions caused by metal rolling), as well as the ductility or spring-back of the metal. Again, alloys AA3004 and AA3104 are not ideal in this regard, and this disadvantage is becoming more significant as there is a trend to produce ever more aggressive shape changes of container walls during necking steps, e.g. to produce metal bottles having narrow necks.

In the case of can end stock and tab stock, alloy AA5184 is usually employed. This is a strong alloy, but one that contains a high content of Mg. Alloys containing Mg oxidize rapidly during rolling and generate an MgO-rich surface oxide layer which can cause low recovery due to poor surface quality. Also, the density of intermetallic particles in high-Mg alloy can be quite low, so the cleaning of tools by surface scrubbing is low, leading to possible metal build-up and consequently poor appearance of the articles so-produced as well as possible die jams leading to equipment shut-down.

There is therefore a need to overcome some or all the problems mentioned above.

The references mentioned below are of interest as they teach the formation sheet structures formed of two or more metal layers.

PCT patent publication WO 2007/118313 A1 in the name of Bull, et al., published on Oct. 25, 2007, discloses a clad sheet article having superplastic properties. The cladding contains a dopant that reacts with an element of the core that otherwise diffuses to the sheet surface and reduces its appearance. The sheet article may be produced by rolling a clad ingot, e.g. an ingot produced by a co-casting process. In one embodiment, alloy AA5083 is clad with a dilute version of alloy AA3003 (Table 2, page 14).

Japanese patent application 93-25573 to Furukawa Aluminum Co., Ltd., published on Feb. 2, 1993 discloses a clad aluminum alloy sheet material intended to produce parts used in marine environments. The sheet material is said to have high strength, good formability and good corrosion resistance. Table 1 of the publication discloses a number of examples in which an AA5000 series alloy is clad with an AA3000 series alloy.

Nevertheless, the problems mentioned above have not been addressed in these references and no solution is provided.

### BRIEF SUMMARY OF THE INVENTION

According to one exemplary embodiment of the present invention, there is provided a sheet article having opposed first and second surfaces, and having a core layer, a cladding layer at the first surface of the sheet article, and optionally a cladding layer at the second surface of the sheet article. The cladding layer at the first surface is made of an aluminum alloy selected from alloys AA3104, AA3004 and modified versions of alloys AA3104 and AA3004 additionally containing 1.0 to 2.0 wt % Fe and optionally up to 1 wt % Si. The core layer is an aluminum alloy having a yield strength and/or ductility greater than the yield strength and/or ductility of the alloy of the cladding layer at the first surface.

The yield strength (YS) of an alloy (often called “yield stress”) is the stress value (load/area) at which the metal changes from elastic to plastic in behavior, i.e. begins to plastically deform or takes on a permanent set. Values of yield strength for various alloys are well known and can be determined empirically by simple known tests. The yield strength of an alloy depends to some extent on the temper of the alloy; however, for non-heat treatable alloys, the core layer and cladding layer(s) will be in the same temper since they will both have been subjected to the same thermo-mechanical treatment (i.e. combination of rolling and thermal treatment). For can body stock produced with conventional thermo-mechanical steps (e.g. cold rolled by about 85% from a soft reroll gauge with some recovery associated with a cold mill exit temperature of about 130 to 150° C.), both the core and the cladding layer(s) will be in the same “H19” temper. Consequently, a comparison of the yield strength values in this temper is appropriate if this is the final temper of the alloys in the sheet article.

The ductility of an alloy is the property that enables the alloy to be mechanically deformed when cold, without fracture. Elongation to failure is a common measure of ductility.

The core layer is preferably made of aluminum alloy having a higher content of Mg than AA3104 and AA3004, and is preferably an alloy having the specification AA5182. Other suitable alloys for the core are alloys are AA5052 and AA5754.

For an understanding of the number designation system most commonly used in naming and identifying aluminum and its alloys see “International Alloy Designations and Chemical Composition Limits for Wrought Aluminum and Wrought Aluminum Alloys”, published by The Aluminum Association, revised January 2001 (the disclosure of which is incorporated herein by reference).

Another exemplary embodiment provides a method of preparing a container body comprising the steps of providing a sheet of container metal, cutting the sheet into blanks, cupping the blanks to form cups, extending the cups by drawing and ironing to form container bodies, trimming the container bodies, and then shaping the container bodies by a number of die necking operations, wherein the sheet of aluminum alloy is a clad metal sheet as defined above.

Yet another exemplary embodiment provides a container body made by the above method, as well as an end wall of a container and a tab intended for a metal container.

In the normal use of the terms within the industry, the clad (or cladding) layer is usually the term given to that layer which dictates surface characteristics such as corrosion resistance or brightness. The core layer is usually the term given to the layer whose primary purpose is to influence the bulk mechanical properties of the overall sheet product. The clad layer is usually, but may not always be, thinner than the core layer. A composite sheet material may consist only of a core layer and a cladding layer, but sheet materials having three or more layers may be provided.

Clearly, in a three or more layer structure, the core layer is generally an internal layer, i.e. the central layer of a three layer structure.

### BRIEF DESCRIPTION OF THE SEVERAL VIEWS OF THE DRAWINGS

Exemplary embodiments of the invention are described in detail in the following with reference to the accompanying drawings, in which:

FIG. 1 is a schematic cross-section of a composite can stock sheet article, shown on a magnified scale, to illustrate one exemplary embodiment of the present invention that may be suitable for either can body stock or can end/tab stock;

FIG. 2 is a perspective view of a beverage container body made of a composite can body stock sheet article according to an exemplary embodiment of the present invention; and

FIG. 3 show an end wall of a beverage container made of a composite can end stock according to an exemplary embodiment of the present invention and also showing a ring pull tab made of a composite tab stock according to another exemplary embodiment of the present invention.

### DETAILED DESCRIPTION OF THE EXEMPLARY EMBODIMENTS

Exemplary embodiments of the present invention relate to can body stock, can end stock and tab stock (referred to collectively as can stock).

### Can Body Stock

Can body stock (CBS) is normally made of a monolithic sheet of aluminum alloy AA3004 or AA3104 (which have yield strength values in conventional can body stock temper of 38 and 40 kilopounds per square inch (ksi), respectively). These metals are chosen because of their compatibility with the drawing and ironing procedure. This procedure involves extending the sides of a short metal cup made from a blank cut from the can body stock. The cup is positioned on the end of a punch and the punch pushes the cup through one or more annular dies (referred to as “ironing rings”) having internal diameters slightly smaller than the outer diameter of the cup, thereby thinning and extending the sidewalls of the cup along the punch to form an elongated container body. The punches and dies typically produce millions of container bodies in this way before being discarded or retooled.

Without wishing to be bound by any particular theory, it is believed that alloys AA3104 and AA3004 are suitable for the drawing and ironing process because they contain intermetallic particles of a kind that “scrub” the ironing tools (punch and die) to prevent metal build up on the tools over time, and thereby avoid metal tear-offs and scoring during the drawing and ironing stage. It is the larger intermetallic particles that are effective for such scrubbing and metals containing insufficient particles of this kind (or an insufficient density of such particles) allow metal build-up since the tooling is not scrubbed sufficiently. However, if there are too many such particles, they may undesirably cause excessive tool wear because the generated friction is then too high. Alloys AA3004 and AA3104 have been found to provide a good compromise in this regard.

The scrubbing effect is apparent both on the die side and on the punch side of the can body stock, but the effect is more critical on the die side because metal build up creates lumps on the die and the lumps produce lines (referred to as scoring) on the resulting container body. Excessive tool wear, on the other hand, produces a rougher die which gives a duller looking container wall. There is usually less concern about the appearance of the inside of the container, so metal build up and tool wear is generally less of a consideration on the punch side provided it does not become excessive. Without the indicated scrubbing action carried out on the drawing and ironing tools, the commercial production of container bodies would not be economic in many or most cases. However, the inventors have determined that the ability of these alloys to scrub the ironing tools is just a surface effect, so it is only necessary to provide the AA3004/3104 alloy (or a modified version thereof discussed below) at the surface of the can body stock that contacts the ironing rings (the surface of the sheet that ultimately forms the exterior of the container body) and possibly also the surface that contacts the ironing punch (the surface ultimately forming the interior of the container body).

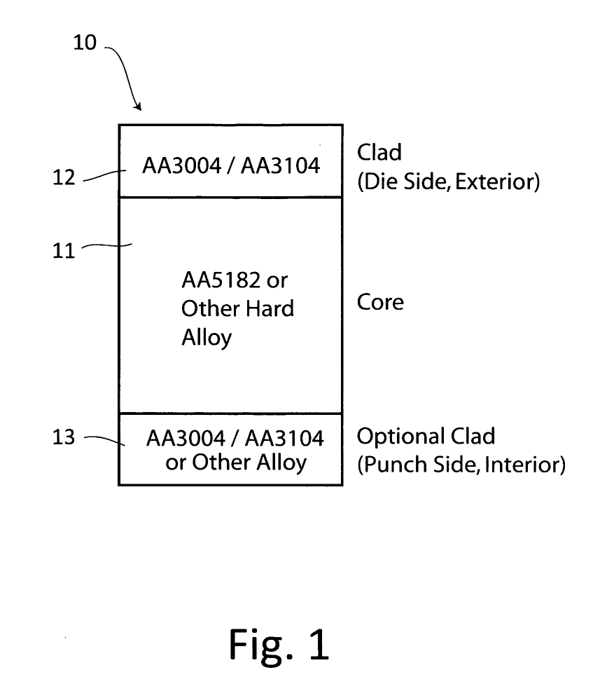

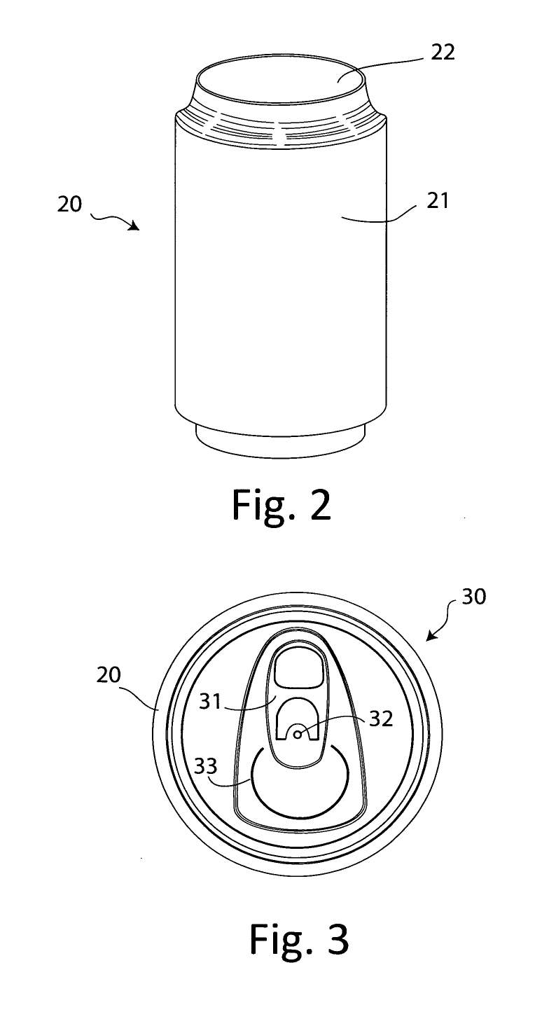

FIG. 1 of the accompanying drawings illustrates one example of a clad or multilayer sheet article according to an exemplary embodiment. FIG. 2 shows a container body 20 made of the sheet article of FIG. 1 and has an exterior surface 21 and an interior surface 22. The sheet 10 has a core layer 11 made of AA5182 or other strong/ductile alloy. One surface of the core layer has a cladding layer 12 made of AA3004 or AA3104 (or a modified version thereof). This is the surface that is chosen to contact the die during drawing and ironing to make a container body, and becomes the exterior surface 21 of the resulting container body 20. The second surface of the core 11 may be unclad or clad with a layer 13 of AA3004/3104 or other alloy (e.g. AA7072). This is the surface that contacts the drawing and ironing punch and becomes the interior surface 22 of a container body 20 made from the sheet article.

In the following description, reference will be made to the use of alloys AA3004/3104 but it should be kept in mind that a modified versions of these alloys containing more iron and possibly silicon may be used when the clad sheet is produced by the procedure of U.S. patent publication no. US 2005/0011630 (referred to in more detail below) or other DC co-casting method, as explained later.

The core layer and the cladding layer of the exemplary embodiments are described in more detail below.

### Core Layer

In the composite or multi-layer can body stock sheet of the exemplary embodiments, there is a core layer and at least one cladding layer. The core layer may be made of an alloy that is better suited to form a container wall of reduced gauge and/or increased strength than alloy AA3004/3104, or one that is better suited for subsequent processing steps, e.g. die necking (which benefits from increased ductility). For example, the alloy chosen for the core may have a greater yield strength than alloys AA3004/3104 (i.e. greater than 38/40 ksi) so that the composite sheet may be made thinner while retaining suitable strength. Alloys of greater ductility than AA3004/3104 are better suited to necking steps because they have less spring-back after being forced into a necking die and then withdrawn. Suitable alloys for the core are therefore alloys that are stronger and/or more ductile than alloys AA3004/3104. Preferably, the alloy of the core is at least 15% stronger (in terms of yield strength) and/or more ductile than the metal of the cladding. More preferably, the core alloy is 25 to 100% stronger or more ductile than alloys AA3004/3104.

A particularly preferred example of such an alloy suitable for the core layer is alloy AA5182 which has a yield strength of 50 ksi as compared to a yield strength of 40 ksi for AA3104 in the H19 temper (i.e. it is 25% stronger). This alloy is also more ductile than AA3004/3104. Alloys of the AA5182 specification are traditionally used to make beverage can end walls (can end stock, CES) that must generally be made stronger than container body walls. Both AA3004/3104 and AA5182 use the same strengthening mechanisms, i.e. work hardening (in the H19 temper) and solid solution strengthening due to the presence of Mg in solid solution.

Alloy AA5182 is not the only example of an alloy suitable for the core layer. AA5182 is stronger than AA3004/3104 because it has a higher content of Mg. It is possible to “tune” the strength of the core alloy by varying the content of Mg, e.g. by making it intermediate between that of AA3004/3104 and AA5182. For example, alloy AA3104 as used in practice contains about 1.2 wt % Mg, and alloy AA5182 contains up to about 4.5 wt % Mg. An intermediate Mg content would therefore be between 1.2 and 4.5 wt % Mg. This may be advantageous in order to make the core alloy somewhat softer than AA5182 so that it deforms more and therefore resists ironing less than AA5182 (even though AA5182 is acceptable for this). In general, it can be said that a core alloy may be made stronger than AA3004/3104 by one or a combination of the following factors:
provide a high Mg level—as in AA5182
provide an intermediate level of Mg
provide a high level of Mg, plus a level of Mn that is higher than in AA5182 (higher than 0.5 wt % Mn)
provide a higher level of Mg than in AA3004/3104 plus an addition of an amount of Cu.

Alloy AA5754 contains an intermediate amount of Mg, but lower amounts of Mn and Cu. This alloy is also suitable for the core layer. Alloy AA5052 is also suitable.

The compositions of these various aluminum alloys in wt % (and other alloys mentioned herein) are as shown in Table 1 below:

TABLE 1

| | Si | Fe | Cu | Mn | Mg | Cr | Zn | Ti |
|---|---|---|---|---|---|---|---|---|
| AA 3004 | 0-0.3 | 0-0.7 | 0-0.25 | 1.0-1.5 | 0.8-1.3 | — | 0-0.25 | — |
| AA 3104 | 0-0.6 | 0-0.8 | 0.05-0.25 | 0.8-1.4 | 0.8-1.3 | — | 0-0.25 | 0-0.10 |
| Typical | | | 0.17 | 0.87 | 1.2 | | | |
| AA3004 | 0-1.0 | 1.0-2.0 | 0-0.25 | 1.0-1.5 | 0.8-1.3 | — | 0-0.25 | — |
| Modified | | | | | | | | |
| AA3104 | 0-1.0 | 1.0-2.0 | 0.05-0.25 | 0.8-1.4 | 0.8-1.3 | — | 0-0.25 | 0-0.10 |
| Modified | | | | | | | | |
| AA 5182 | 0-0.20 | 0-0.35 | 0-0.15 | 0.2-0.5 | 4.0-5.0 | 0-0.10 | 0-0.25 | 0-0.10 |
| Typical | | | | | | | | |
| (−01 CES) | | | 0.04 | 0.33 | 4.55 | | | |
| (−05 CES) | | | 0.04 | 0.48 | 4.63 | | | |
| AA5754 | 0-0.40 | 0-0.40 | 0-0.10 | 0-0.50 | 2.6-3.6 | 0-0.30 | 0-0.20 | 0-0.15 |
| AA5052 | 0-0.25 | 0-0.40 | 0-0.10 | 0-0.10 | 2.2-2.8 | 0.15-0.35 | 0-0.10 | — |

| | | | | | | | |
|---|---|---|---|---|---|---|---|
| AA7072 | Si + Fe | 0-0.10 | 0-0.10 | 0-0.10 | — | 0.8-1.3 | — |
| | 0-0.7 | | | | | | |
| AA1100 | 0-0.95 | 0.05-0.20 | 0-0.05 | — | — | 0-0.10 | — |

It will be seen from Table 1 that alloy AA5182 contains a higher amount of Mg than either AA3004 or AA3104, which makes AA5182 much stronger but also more ductile.

### Cladding Layer

The cladding layer on at least the die side of the can body stock is made of alloy AA3004/3104 or a modification thereof as explained later. The cladding layer of this alloy is preferably made quite thin. It is believed to be the larger intermetallic particles of these alloys that are responsible for the scrubbing effect, i.e. particles in the size range of 5-10 μm. The size range of these particles sets the lower limit for the thickness of the cladding layer after ironing. Based on this, the minimum thickness of the cladding (after ironing) may be 5-20 μm. The upper part of this range goes beyond the size range of the particles for appearance reasons. That is to say, if the cladding thickness is too close to the particle size, the cladding layer may not remain fully intact after ironing, i.e. a void may be created due to the inability of the bulk phase of the metal to cover and/or fill in behind a particle that becomes exposed as the side wall thins.

As for the maximum clad thickness values, there is no upper limit, but the maximum values must be compatible with achieving the desired minimum strength and/or ductility requirements of the composite sheet (while also optionally providing a sheet of reduced gauge compared to conventional can body stock made of AA3004/3104 alloy). It is therefore desirable to make the thickness of the cladding close to the minimum acceptable values mentioned above. In practice, a cladding thickness in the range of 5 to 100 μm is often preferred. In the as-rolled form (prior to ironing) it is preferable to specify the thickness as a percentage of the total thickness of the material. Table 2 shows examples of suitable cladding layer thicknesses:

TABLE 2

| Target Ranges | AS ROLLED¹ | AS IRONED² |
|---|---|---|
| Working | 2-30% | 0.0002-0.0020 (5-51 μm) |
| Preferred | 5-15% | 0.0004-0.0010 (10-25 μm) |
| Most Preferred | 10-12.5% | 0.0008-0.0009 (20-23 μm) |

¹% of total sheet thickness (as rolled gauge = 0.008-0.030 inch or 0.2-0.8 mm)
²based on “as-ironed” gauge of mid-sidewall of 0.003-0.007 inch or 0.076-0.178 mm

As noted above, the lowest limit of the as-ironed clad thickness of 5 μm or 0.0002 inch is set by the lower limit on the size of the intermetallic particles. The most preferred lower limit of 20 μm or 0.0008 inch is twice the diameter of the largest intermetallic particles to help to ensure the maintenance of a continuous film of intact clad metal after ironing. The most preferred upper limit of 12.5% of the sheet thickness for the cladding prior to ironing (see Table 2) is chosen because such a thickness makes it possible to produce a clad structure with essentially the same strength rating as that of a single layer of the same alloy, e.g. alloy AA5182. Since the strength of the composite sheet will then be essentially the same as AA5182 itself, and since this alloy is about 25% stronger than a single layer of AA3004/3104, the can composite body stock can be made much thinner than conventional can body stock made of a single layer of AA3004/3104.

The above description relates to the cladding on the side of the sheet intended to contact the ironing die. The provision of a cladding layer on the opposite side (ironing punch side) is optional. Thus, the opposite side of the core may remain unclad or, alternatively, may be clad with a layer of AA3004/3104 or another metal having desirable properties. If clad with AA3004/3104, the comments above regarding the thickness of the cladding layer on the die side apply also to the thickness of the cladding layer on the punch side. The punch side of the sheet is the side that, in the finished container, will be exposed to the container contents which, for example in the case of many soft drinks and sports drinks, may be quite acidic or corrosive. Thus, if AA3004/3104 is not needed to prevent metal build-up, a cladding layer that resists corrosion in such conditions, or provides some other benefit, may be provided instead. The particular alloy and thickness chosen for this layer will depend on the desired performance parameters. Other suitable alloys for the cladding on this side may be ones that are beneficial to the container forming process, the container strength, the contents that the container will hold (e.g. to resist imparting a metallic taste), etc. An Al—Zn alloy such as AA7072 (see Table 1) is suitable for such reasons as an alloy for the cladding layer on this side.

Alloy AA1100 (an essentially pure aluminum alloy containing a little copper) may also be used for the cladding layer on the punch side because it is easy to clean before contact with beverages and the like. Container bodies are often washed with acid cleaning solutions to remove oils and other contaminants and it is desirable to minimize the amount of the solution employed. Counter-intuitively, surfaces that are soft and crack easily under hydrodynamic pressure (during rolling using viscous rolling lubricants) are easier to clean than smooth surfaces. This is because there is more surface area exposed in the former case and the acid more easily dissolves impurities that are in or just below the surface. In the case of a smooth surface, it may be necessary to etch away an entire layer of metal before the desired cleaning effect is achieved. Therefore, alloy AA1100 and other similar alloys that have such properties are preferred.

In some embodiments, there may be more than just two or three layers. While the core layer provides desirable bulk characteristics and the cladding layer(s) provide the desired compatibility with drawing and ironing equipment or protection of (or from) container contents, or the like, one or more internal layers or so-called interlayers may also be provided between the core layer and a cladding layer. One reason for this would be, for example, to prevent alloying elements from migrating from one layer to another. For example, a core layer with a high content of a fast-diffusing element such as Mg may lose Mg due to diffusion into the cladding layer(s) during homogenization. An intervening layer of a metal that slows or prevents such migration may be provided. Such a layer would preferably only be as thick as required to prevent significant diffusion so as to have little impact on the strength, thicknesss or other properties of the overall alloy sheet article.

The can body stock according to the exemplary embodiments may be coated after container body formation with paint layers or protective layers (on the exterior) and coating layers of polymers or the like (on the interior) in conventional ways.

Can body stock according to the exemplary embodiments may be used in the same way as conventional can body stock for the production of container bodies. It is also possible to produce container bodies of all conventional sizes and shapes. Of course, if the gauge of the stock differs from the conventional gauge, standard adjustments of the tools would have to be made in order to accommodate the gauge difference.

Alloy sheet according to the exemplary embodiments may be used in the same way as conventional can body stock for the production of container bodies. Of course, if the gauge of the stock is less than the conventionsl gauge, standard adjustments of the tools would have to be made in order to accommodate the gauge difference. It is also possible to produce container bodies of all conventional sizes and shapes.

### Can End Stock and Tab Stock

FIG. 3 shows an example of a can end wall 30 having a ring pull opening device or tab 31 connected to the end wall at contact point 32. The end wall has a score 33 that defines an area of the end wall that opens when the tab is lifted and pivoted about contact point 32. The can end wall is joined to a container body 20 as shown in FIG. 2 to make a completed container.

As mentioned earlier, can end stock and tab stock suffer from disadvantages when made from a high Mg alloy such as AA5182. For example, while can ends and tabs are not subjected to drawing and ironing, they are nevertheless passed through cutting and shaping tools and dies that may themselves be subject to metal build-up, and the associated problems, as a result of such contact. It is therefore advantageous to use a sheet stock that has a cladding of AA3004/3104 on at least one side thereof (a side that has most contact with a processing tool) in order to obtain the scrubbing effect of those alloy. It is also found that, during rolling, alloys AA3004/3104 form an extremely clean and coherent surface oxide on the rolls, thus protecting the roll and the sheet surface from the formation of streaks and surface defects. It is theorized that, in a composite sheet according to exemplary embodiments, the Al—Mn alloy of AA3004/3104 protects the ingot and sheet from out-diffusion of Mg from the core, and therefore from Mg oxide formation at the surfaces. For this reason, it is advantageous to employ sheet clad with AA3004/3104 overlying a higher Mg core (e.g. AA5182) for can end and tab stock. There may therefore be down-stream processing advantages and less sheet rejection. As a further possible advantage, can end and tab stock of this kind may be clean enough to be rolled by the same rolls as those used for can body stock, thus making better use of rolling equipment (currently different rolls are used because of the poor quality of the sheet surface due to the formation of magnesium oxides).

The can end and tab stock may employ the same cladding structures as those described for the can body stock, although the metal thicknesses employed for these applications may differ (generally can end stock is used in thicker gauge than can body stock). Also, if there is a cladding layer on both sides of the core layer, alloys AA3004/3104 are usually chosen for both layers.

### Production of Clad Can Stock

Clad structures of the kind used in the exemplary embodiments may be produced by various methods, e.g. by diffusion bonding (in which slabs, plates or ingots of the different metals are specially treated and contacted to form a metallurgical bond when heated to a high temperature below the melting point) or roll bonding (in which slabs, plates or ingots of the different metals are mechanically attached together by welding or the use of straps, and then rolled to the desired thickness). However, it is most preferable to produce the illustrated structures by hot and cold rolling from a composite or multi-layer metal ingot. There are several techniques for producing such ingots, e.g. simultaneously direct chill (DC) co-casting two or more metal layers, sequentially casting one or more layers on a core layer that has already solidified, or sequentially contacting a molten metal with a semi-solid surface of a layer previously cast. Some of these methods involve the use of chilled divider walls to separate the entrance of a chilled casting mold into two or more compartments, and the use of cooling water that is poured onto the surface of the ingot as it emerges from the mold. U.S. patent publication no. US 2005/0011630, naming Anderson et al. as inventors, published on Jan. 20, 2005 (the disclosure of which is specifically incorporated herein by this reference) relates to a method involving the use of one or more chilled divider walls in a chilled mold to bring about contact of a molten metal with a semi-solid surface of a layer previously cast (i.e. it involves sequential co-casting onto a semi-solid surface in a chilled wall mold employing a chilled divider wall and cooling water poured onto the emerging ingot). This method in particular advantageously assures that the layers are continuous and dense (i.e. solid metal throughout without voids or structures made of discrete interconnected particles, e.g. as produced from rolled solid ingot, plate or slab) and that a good metallurgical bond is achieved between the various layers. The resulting ingot may be subjected to heat homogenization, and then hot and cold rolling of the ingot to produce a sheet article of desired final gauge suitable for can body stock, can end stock or tab stock. During a long homogenization period, magnesium from the core layer may diffuse into the cladding layer and give rise to a diffuse concentration gradient rather than an abrupt interface. This may be advantageous to avoid sharp stress ambiguity. It is also to be noted that alloys containing Mg, such as AA5182 and other 5000 series alloys, are prone to oxidation so that it is difficult to combine such alloys with layers of other alloys by more conventional means. Consequently, the procedure of US 2005/0011630 is preferred for this reason as well.

It has further been noticed that, when casting processes involving the use of chilled molds having chilled divider walls and poured cooling water (e.g. the process of US patent publication no. 2005/0011630 in particular) are used to produce a composite (multi-layer) ingot having a cladding of alloy AA3004/3104 on one or both main surfaces, the cladding may have a lower density of intermetallic particles than when a cladding of alloy AA3004/3104 is produced in other ways (e.g. as produced from monolithic slabs joined by roll bonding and the like). This may be because, when a composite ingot with a relatively thin cladding layer is cast by such a process, the cladding layer is rapidly cooled throughout by the chilled mold walls, the chilled divider walls and the cooling water applied to the surface of the ingot, so large intermetallic particles have less opportunity to form and grow in size than when casting is carried out in other ways. Since the presence of large intermetallic particles in the cladding layer(s) in relatively high density is desired for the reasons given herein, it is desirable to promote their formation when using such casting techniques and equipment by adding more iron and possibly silicon to the known AA3104/3004 formulation. Therefore, for clad can stock formed by this route, the cladding alloy may have the formulation or specification of AA3104/3004 modified to include Fe in an amount of 1 to 2 wt %, and/or Si in an amount up to 1 wt % (i.e. 0 to 1 wt %). Such alloys and their formulations are shown as alloy “AA3004 Modified” and alloy “AA3104 Modified” in Table 1 above.

What we claim is:

1. A sheet article having opposed first and second surfaces, said sheet article comprising a core layer, a cladding layer at said first surface of the sheet article, and optionally a cladding layer at said second surface of the sheet article, wherein said cladding layer at said first surface is made of an aluminum alloy selected from the group consisting of alloys AA3104, AA3004 and modified versions of alloys AA3104 and AA3004 additionally containing 1.0 to 2.0 wt % Fe and optionally up to 1 wt % Si, and the core layer is an aluminum alloy having a yield strength and/or ductility greater than the yield strength and/or ductility of the alloy of said cladding layer at said first surface.

2. The sheet article of claim 1, wherein said aluminum alloy of said core layer has a yield strength greater than 40 ksi.

3. The sheet article of claim 1, wherein the core layer is made of an aluminum alloy having a content of Mg higher than 1.2 wt %.

4. The sheet article of claim 1, wherein the core layer is made of an aluminum ally having a content of Mg in a range of 1.2 to 4.5 wt %.

5. The sheet article of claim 3, wherein the core layer is made of aluminum alloy selected from the group consisting of AA5182, AA5754 and AA5052.

6. The sheet article of claim 1, wherein a cladding layer is provided at said second of said opposed surfaces, said cladding layer on said second opposed surface being an aluminum alloy selected from the group consisting of alloys AA3104, AA3004 and modified versions of alloys AA3104 and AA3004 containing 1.0 to 2.0 wt % Fe and optionally up to 1 wt % Si.

7. The sheet article of claim 1, wherein a cladding layer is provided at said second of said opposed surfaces, said cladding layer on said second opposed surface being an aluminum alloy other than said alloys AA3104, AA3004 and modified versions of alloys AA3104 and AA3004 containing 1.0 to 2.0 wt % Fe and optionally up to 1 wt % Si.

8. The sheet article of claim 7, wherein said cladding layer at said second surface of said opposed surfaces is an aluminum alloy containing zinc.

9. The sheet article of claim 8, wherein said aluminum alloy containing zinc is alloy AA7072.

10. The sheet article of claim 7, wherein said cladding layer at said second of said opposed surfaces is alloy AA1100.

11. The sheet article of claim 1, wherein said cladding layer at said first surface has a thickness of at least 2% of a total thickness of said sheet article.

12. The sheet article of claim 6, wherein said cladding layer at said second surface has a thickness of at least 2% of a total thickness of said sheet article.

13. The sheet article of claim 1, having a gauge suitable for can body stock.

14. The sheet article of claim 1, having a gauge suitable for can end stock.

15. The sheet article of claim 1, having a gauge suitable for tab stock.

16. The sheet article of claim 1 having been produced by hot and cold rolling of a direct chill co-cast or sequentially-cast composite ingot, wherein said cladding layer at said first surface is made of an aluminum alloy selected from the group consisting of alloys of specification AA3104 and AA3004 additionally containing 1.0 to 2.0 wt % Fe and optionally up to 1 wt % Si.

17. The sheet of claim 16 having been produced by hot and cold rolling of a co-cast or sequentially-cast ingot formed in a chilled mold having at least one chilled divider wall employing cooling water poured onto said ingot as it emerges from the mold.

18. The sheet of claim 17, wherein said sheet is formed from a sequentially-cast ingot formed by a process as disclosed in US patent application publication no. 2005/0011630.

19. A method of preparing a container body comprising the steps of providing a can body stock sheet article, cutting the sheet article into blanks, cupping the blanks to form cups, extending the cups by drawing and ironing to form container bodies, trimming the container bodies, and then shaping the container bodies by a number of die necking operations, wherein said sheet article is as defined in claim 1.

20. A container body made by the method of claim 19.

21. The container body of claim 20 wherein said cladding layer, after said drawing and ironing step, has a thickness of 5 to 100 μm.

22. The container body of claim 20, wherein said cladding layer, after said drawing and ironing step, has a thickness of 5 to 20 μm.

23. A container end wall made of the sheet article according to claim 14.

24. A tab for a metal beverage container, said tab being a shaped article made of the sheet article of claim 15.
